(19) United States
(12) Patent Application Publication
(10) Pub. No.: US 2002/0179770 A1
(43) Pub. Date: Dec. 5, 2002

(54) Flat balloon

(76) Inventor: Alexander Liss, New York, NY (US)

Correspondence Address: ALEXANDER LISS, 333 E 66 ST APT 5C, NEW YORK, NY, 10021, US

(21) Appl. No.: 09/681,769

(22) Filed: Jun. 1, 2001

(51) Int. Cl. B64B 1/02

(52) U.S. Cl. 244/30

(57) ABSTRACT

A Flat Balloon—a set of gas-bags held together with a net, which has rigid elements keeping an entire construction flat, with control ropes attached to the net, which allow spreading of the Flat Balloon over a field and folding it; a tubular net inside a gas-bag filed with rigid elements, which allows pumping gas out; a material with closed pores filed with lightweight gas.

### BACKGROUND OF INVENTION

Different modifications of balloons, blimps, dirigibles or airships and their applications are described in following U.S. patents:

6,196,498 Eichstedt, et al. Mar. 6, 2001

6,019,311 Thyen Feb. 1, 2000

5,931,413 Hayashi Aug. 3, 1999

5,823,468 Bothe Oct. 20,1998

5,697,579 Hayashi Dec. 16, 1997

5,143,322 Mason Sep. 1, 1992

5,005,783 Taylor Apr. 9,1991

4,695,012 Lindenbaum Sep. 22, 1987

4,497,272 Veazey Feb. 5, 1985

4,012,016 Davenport Mar. 15,1977

### SUMMARY OF INVENTION

An invention is a Flat Balloon—a set of gas-bags held together with a net or a cover, which has rigid elements keeping an entire construction flat. The Flat Balloon can be used for advertisement, entertainment, as a sail of a boat or with a gondola for transportation. It is controlled with ropes attached to its net and through pumping gas out of gas-bags. It can be spread over a field, folded with gas in it or twisted. Engines move propellers attached to the gondola and the direction of the force exerted by propellers can be changed. The Flat Balloon movement in the air is controlled with positioning its broad side at a proper angle to the wind and positioning of its propeller at a proper angle to its broad side.

An additional invention is a tubular net filled with rigid elements and placed inside a gas-bag, which prevents a gas-bag from collapsing on an opening of pump in the gas-bag during pumping gas out the gas-bag.

An additional invention is a lightweight material with closed pores filled with lightweight gas. It can be made by producing foam in an atmosphere of lightweight gas.

### DETAILED DESCRIPTION

Wind carries a balloon (or a blimp) in its direction. The maximum area of the balloon's cross-section by a plane perpendicular to this direction defines the force exerted by the wind on the balloon. If we can make the balloon vertically flat, then we can make its movement more controllable. We can turn its narrow side to the wind to minimize the wind's force, for example when we use an engine to move against the wind, or we can turn to wind a balloon's broad side, for example when we want to move in wind's direction.

A balloon of a flat shape has additional advantages. It provides more surfaces usable for advertisement. When it is anchored, it can be spread over a field and thus protected from a strong wind. It can be folded before being spread, to fit in a building. It can be used as a sail of a boat.

An invention is a Flat Balloon—a set of gas-bags, preferably long and narrow as weather balloons, held together with a net or a cover, which has rigid elements keeping an entire construction flat. For example, rigid elements could be lightweight tubes tied in pairs by ropes, that one tube is on one broad side of the Flat Balloon and the other on another side of it. These pairs of tubes can be embedded into the net for each gas-bag separately or for a few of them together.

Gas can be pumped out of some of these gas-bags to reduce buoyancy of the Flat Balloon. However, gas-bags have a tendency to collapse on the opening of the pump, while gas is pumped out. To prevent this, there are gas-ways inside gas-bags. Such gas-way is a tubular net inside a gas-bag filled with lightweight rigid elements, for example hollow bolls with holes. One end of it is attached to gas-bag's top and the other end coincides with an opening of a pump.

Note that gas-way can be used in a general case of pumping gas from a gas-bag; gas does not need to be lightweight.

A gondola—preferably elongated, is connected to the Flat Balloon'net or cover: its long side along the broad side of the Flat Balloon.

Engines are connected to the gondola and move the Flat Balloon together with the wind, as it is done in blimps or dirigibles. It is desirable that a direction of force exerted by engines on the Flat Balloon can be controlled. For example, angles between axes of propellers and a broad side of the Flat Balloon can be changed, that there is a better control over the movement of the Flat Balloon.

Long ropes are attached to the net—its top and other places in between. They are used to pin down the Flat Balloon to the ground, to spread it over a field, to fold it and to change its shape during operations.

A cover above gas-bags and underneath the net protects gas-bags from tear. Another cover above the net with control ropes pooled through it supplies a continuos surface convenient for advertisement.

One broad side of a Flat Balloon is white or of a bright color and the other broad side is black or of a dark color. Turning dark side of the Flat Balloon to the sun causes its gas to heat-up and increases Flat Balloon's buoyancy. Turning its bright side to the sun causes sun rays to be reflected and temperature of the Flat Balloon gas to get in line with outside temperature; this usually decreases Flat Balloon's buoyancy.

Lightweight materials are useful with a gondola. One such material is made as plastic foam in an atmosphere of lightweight gas. When foam hardens it keeps lightweight gas in it. The result is a material with lightweight gas in its closed pores.

1. A flying object—a Flat Balloon, which consists of:
one or a few gas-bags filled with lighter than air gas a net or a cover holding them together, to which can be attached a gondola or which can be attached to an anchor rigid elements of the net or a cover, for example pairs of horizontal tubes on both sides of the gas-bags tied together in the net, which cause gas-bags to have a flat shape.

2. The method of claim 1, where the Flat Balloon is spread over a field, while it is anchored.

3. The method of claim 1 where the Flat Balloon is folded, for example while it is anchored.

4. The method of claim 1, where the Flat Balloon is used to display advertisement materials on its broad sides.

5. The method of claim 1 where the Flat Balloon is used as a sail of a boat.

6. The method of claim 1, where gas is pumped out of some gas-bags to reduce the Flat Balloon's lifting force.

7. The Flat Balloon of claim 1, where control ropes are attached to the net—to its top and other places, which can be used to spread the Flat Balloon over a field, to fold it or to twist its shape.

8. The Flat Balloon of claim 1, where a gondola is attached to its net.

9. The Flat Balloon of claim 8, where a force is applied to the gondola to move it, for example with help of engines and propellers.

10. The Flat Balloon of claim 9, where the direction of force can be changed, for example by changing angles between a broad side of the Flat Balloon and axes of propellers producing it.

11. The Flat Balloon of claim 1, where one of its broad sides is of a dark color (black) and the other of a bright color (white).

12. The method of claim 11, where the bright side of it is turned to the sun to keep its gas cool and the dark side is turned to the sun to heat it.

13. The Flat Balloon of claim 1, where a cover is placed over its net with control ropes pulled through it.

14. The Flat Balloon of claim 1, where a cover is placed over its gas-bags and underneath its net.

15. In a closed gas-bag, a tubular net filed with rigid elements, for example with hollow bolls with holes, one end of which is attached to one end of the gas-bag and the other end of it is attached to an opposite end of the gas-bag.

16. A method of claim 15, where a gas-pump opens into the gas-bag in the area of one of the ends of the tubular net that gas can be pumped out without collapsing gas-bag preventing it.

17. A lightweight material with closed pores filled with lightweight gas.

18. The method of claim 17, where the lightweight material is produced as a plastic foam in atmosphere of lightweight gas, which captures and keeps this gas in its pores, when it hardens.
